(19) United States
(12) Patent Application Publication
(10) Pub. No.: US 2011/0209183 A1
(43) Pub. Date: Aug. 25, 2011

(54) METHOD AND APPARATUS FOR TRANSMITTING DATA BASED ON AUDIO/VIDEO INTERFACE

(75) Inventors: Il-ju NA, Yongin-si (KR); Jae-min LEE, Suwon-si (KR); Seung-kwon PARK, Yongin-si (KR); Bong-hwan CHO, Suwon-si (KR)

(73) Assignee: SAMSUNG ELECTRONICS CO., LTD., Suwon-si (KR)

(21) Appl. No.: 13/034,970

(22) Filed: Feb. 25, 2011

Related U.S. Application Data
(60) Provisional application No. 61/282,525, filed on Feb. 25, 2010.

(30) Foreign Application Priority Data
May 4, 2010 (KR) 10-2010-0042073

(51) Int. Cl. H04N 7/18

(52) U.S. Cl. 725/80; 725/74

(57) ABSTRACT

Provided are a method and an apparatus for forming a network with various audio/video (AV) devices via a link established by using an AV interface supporting bidirectional data transmission and for transmitting and receiving various types of data via the AV interface.

### CROSS-REFERENCE TO RELATED PATENT APPLICATION

This application claims the benefit of U.S. Provisional Application No. 61/282,525, filed on Feb. 25, 2010, in the U.S. Patent and Trademarks Office, and Korean Patent Application No. 10-2010-0042073, filed on May 4, 2010, in the Korean Intellectual Property Office, the disclosures of which are incorporated herein in their entirety by reference.

### BACKGROUND

1. Field

The exemplary embodiments relate to a method and an apparatus for transmitting data based on an audio/video (AV) interface, and more particularly, to a method and an apparatus for transmitting data based on a digital audio/video (AV) interface.

2. Description of the Related Art

A source device which provides audio/video (AV) data and a sink device which receives AV data from the source device and reproduces the AV data are connected to each other via a predetermined AV interface.

For example, a source device and a sink device may be connected to each other via an AV interface, such as a digital video/visual interactive (DVI) interface or a high-definition multimedia interface (HDMI), for transmission of digital AV data.

### SUMMARY

Exemplary embodiments provide a method and an apparatus for transmitting data via an audio/video (AV) interface with improved efficiency.

Exemplary embodiments also provide a computer readable recording medium having recorded thereon a computer program for implementing the method.

According to an aspect of exemplary embodiments, there is provided a method, performed by a first device, of transmitting and receiving data between the first device and a second device, the method including performing at least one of transmitting data to the second device and receiving data from the second device via a link, which is based on an audio/video (AV) interface and supports bidirectional transmission of non-compressed video data.

The link may include a plurality of sub-links capable of transmitting and receiving the data.

The plurality of sub-links may include at least one sub-link used only for data transmission and at least one sub-link used only for data reception.

The link may include a plurality of sub-links, and the plurality of sub-links may include a sub-link supporting data transmission only, a sub-link supporting data reception only, and at least one sub-link supporting both data transmission and data reception.

The plurality of sub-links may include at least one sub-link used only for at least one of transmission and reception of a particular type of data.

The plurality of sub-links may respectively correspond to a plurality of lanes which indicate physical connections between the first device and the second device via the AV interface.

The performing of at least one of transmitting data to the second device and receiving data from the second device may include transmitting a plurality of packets by using time-division duplexing of at least one of the plurality of sub-links used for data transmission.

The performing of at least one of transmitting data to the second device and receiving data from the second device may include receiving a plurality of packets by using time-division duplexing of at least one of the plurality of sub-links used for data reception.

The plurality of packets may include video data packets corresponding to a plurality of AV streams.

The plurality of packets may include at least one of an audio data packet, an Ethernet data packet, a universal serial bus (USB) data packet, and a control data packet, which is transmitted and received for controlling another device.

The plurality of packets may include at least one packet received from at least one external device.

The transmitting of data to the second device may include transmitting the at least one packet received from at least one external device by link layer switching.

The performing of at least one of transmitting data to the second device and receiving data from the second device may include establishing a link, which supports bidirectional transmission of non-compressed video data based on the AV interface, to the second device; and performing at least one of transmitting data to the second device and receiving data from the second device via the established link.

The method may further include setting directions and rates of data transmission of the plurality of sub-links during a link setup period before the performing of at least one of transmitting data to the second device and receiving data from the second device.

According to another aspect of exemplary embodiments, there is provided a data transmitting and receiving device of a first device for transmitting and receiving data to and from the second device, the component device including an AV interface for performing at least one of transmitting data to the second device and receiving data from the second device via a link, which is based on an audio/video (AV) interface and supports bidirectional transmission of non-compressed video data.

The data transmitting and receiving device may further include a link setup unit for setting directions and rates of data transmission of the plurality of sub-links during a link setup period before the performing of at least one of transmitting data to the second device and receiving data from the second device.

According to another aspect of exemplary embodiments, there is provided a computer readable recording medium having recorded thereon a computer program for implementing the method of transmitting and receiving data.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a diagram showing a network topology of devices connected via an audio/video (AV) interface according to an exemplary embodiment;

FIG. 2A is a diagram showing bidirectional data transmission via an AV interface according to an exemplary embodiment;

FIG. 2B is a diagram showing bidirectional data transmission via an AV interface according to another exemplary embodiment;

FIG. 2C is a diagram showing a switch device according to an exemplary embodiment;

FIG. 2D is a diagram showing network layer structure of an AV interface according to an exemplary embodiment;

FIG. 3A is a diagram showing a device including an AV interface according to an exemplary embodiment;

FIG. 3B is a diagram showing mapping between the HDMI and an AV interface, according to an exemplary embodiment;

FIG. 4 is a diagram showing a link established based on an AV interface according to an exemplary embodiment;

FIGS. 5A through 5F are diagrams showing a plurality of sub-links for bidirectional data transmission according to an exemplary embodiment;

FIGS. 6A through 6F are diagrams showing a plurality of sub-links for bidirectional data transmission according to another exemplary embodiment;

FIG. 7A is a diagram showing transmission and reception of data using time-division duplexing according to an exemplary embodiment;

FIG. 7B is a diagram showing transmission and reception of data using time-division duplexing and space-division duplexing according to an exemplary embodiment;

FIGS. 8A and 8B are diagrams showing a plurality of sub-links for bidirectional data transmission according to another exemplary embodiment;

FIG. 9 is a diagram showing a plurality of sub-links for bidirectional data transmission according to another exemplary embodiment; and

FIG. 10 is a flowchart for describing in more detail a method of transmitting and receiving data based on an AV interface according to an exemplary embodiment.

### DETAILED DESCRIPTION

Hereinafter, the inventive concept will be described in detail by explaining exemplary embodiments with reference to the attached drawings.

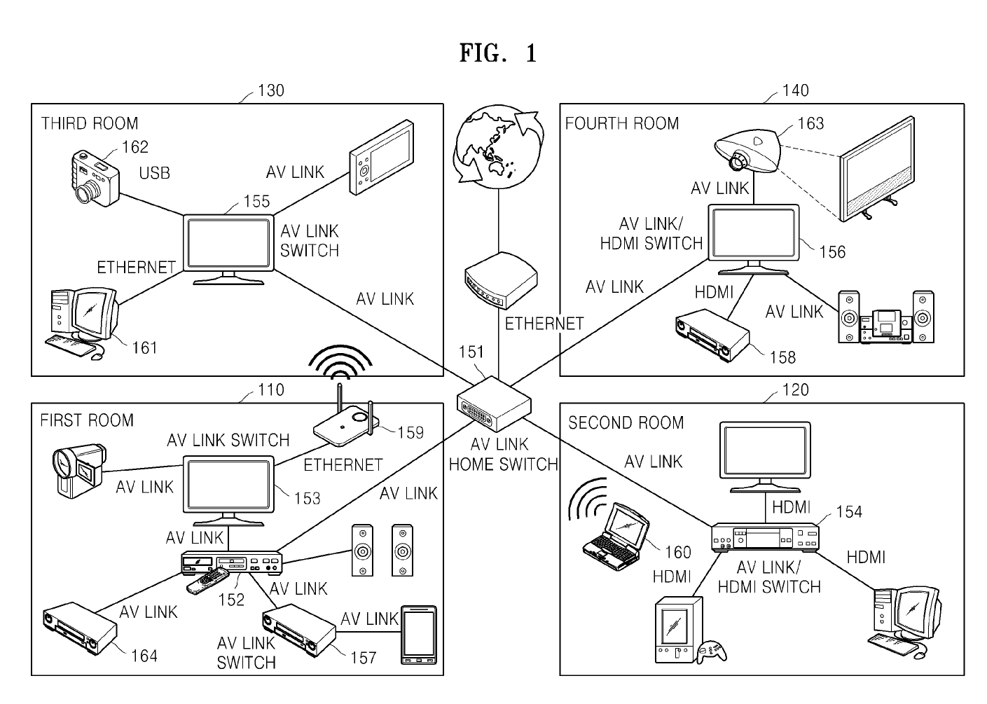

FIG. 1 is a diagram showing a network topology of devices connected via an audio/video (AV) interface according to an exemplary embodiment. The AV interface refers to an interface for transmitting AV data. In FIG. 1, ‘AV link’ refers to a link established based on an AV interface according to an exemplary embodiment, and ‘HDMI’ refers to a connection via a high-definition multimedia interface (HDMI) cable.

Referring to FIG. 1, AV devices may form a network via the AV interface according to the present embodiment. AV devices located at a plurality of rooms may be connected to various types of AV devices located in the same rooms or in different rooms via an AV interface according to an exemplary embodiment. Here, an AV link relaying switch device for relaying connections based on an AV interface relays connections based on the AV interface. The switch device may be either a separate device for relaying AV links, such as an AV link home switch 151, or AV devices 152, 153, 154, 155, 156, and 157 with integrated switch functions. An AV receiver 152, a TV 153, and a Blu-ray player 157, which are AV devices, function as switch devices in a first room 110, whereas TVs 155 and 156, which are AV devices, respectively function as switch devices in third and fourth rooms 130 and 140.

Furthermore, a switch device may be a device for switching between an AV interface according to an exemplary embodiment and a HDMI. For example, a switch device 154 in a second room 120 may receive AV data from a PC and a game console via the HDMI and may transmit received AV data to devices in the first room 110, the third room 130, or the fourth room 140 via an AV interface according to an exemplary embodiment.

Devices within the network shown in FIG. 1 may be categorized as source/leaf devices, source/switch devices, switch devices, sink/switch devices, and sink/leaf devices, according to functions of the devices.

A device providing AV data and not relaying an AV link, such as a set-top box 164 in the first room 110, corresponds to a source/leaf device, whereas a device providing AV data to another device and relaying an AV link, such as an AV receiver 152 in the first room 110, corresponds to a source/switch device. Furthermore, a device only relaying an AV link, such as the AV link home switch 151, corresponds to a switch device, whereas a device receiving AV data from another device and relaying an AV link, such as the TV 156 in the fourth room 140, corresponds to a sink/switch device. Furthermore, a device receiving AV data from another device and not relaying an AV link, such as a projector 163 in the fourth room 140, corresponds to a sink/leaf device.

In the network structure shown in FIG. 1, AV data of the Blu-ray player 157 in the first room 110 may be transmitted to the TV 155 in the third room 130 or the TV 156 in the fourth room 140 via the AV receiver 152 and the AV link home switch 151. Furthermore, broadcast signals received by a set-top box 158 in the fourth room 140 may be transmitted to the TV 153 in the first room 110 via the AV link home switch 151 and the AV receiver 152.

In other words, it is necessary for an AV interface according to an exemplary embodiment to support bidirectional data transmission for freely transmitting and receiving AV data in a network using AV links as shown in FIG. 1.

Conventional AV interfaces, such as DVI and HDMI, only support monodirectional data transmission from a source device to a sink device. Via a conventional AV interface, such as DVI and HDMI, AV data of a source device may only be transmitted to a sink device, and the sink device is unable to transmit AV data to the source device. For example, the TV 156, which is a sink device in the fourth room 140, is only able to receive AV data from the set-top box 158 connected via HDMI and is unable to transmit AV data to the set-top box 158.

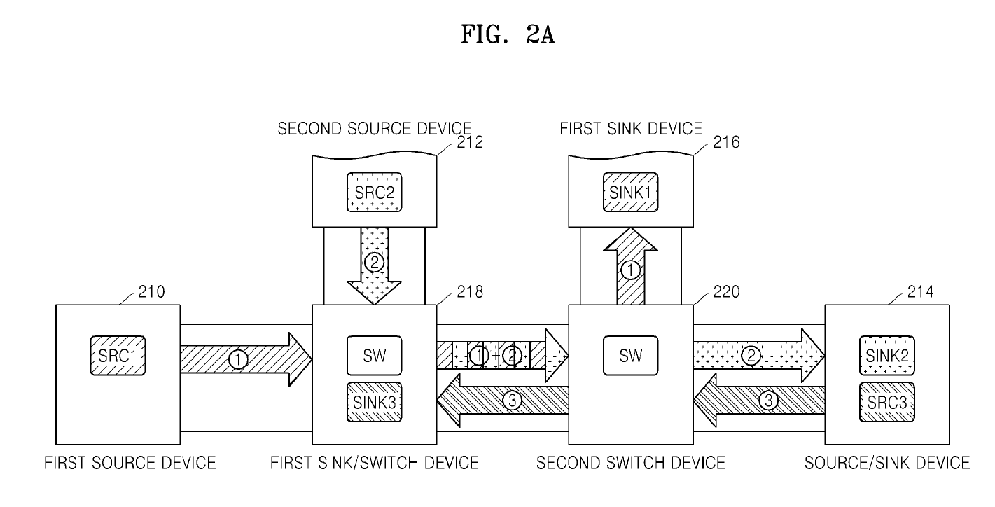

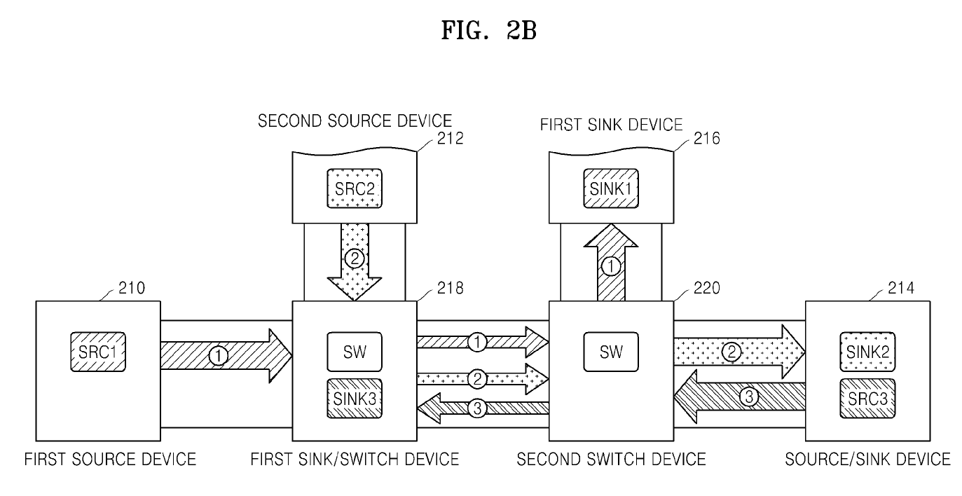

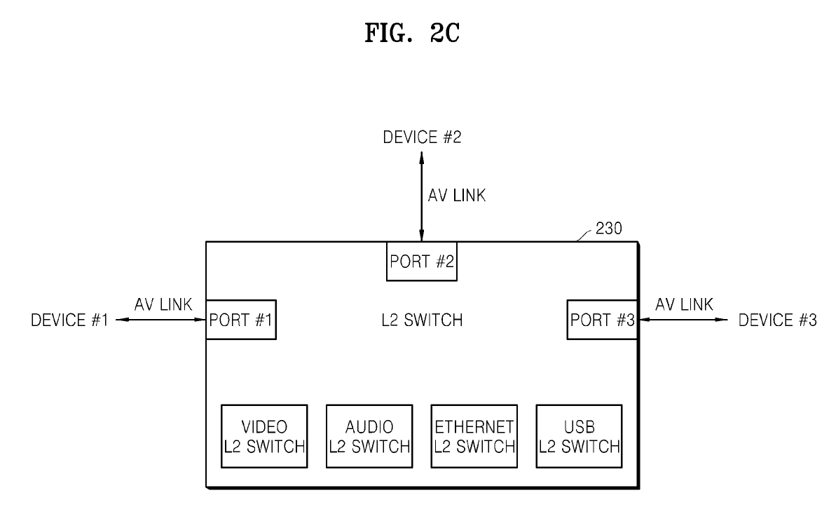

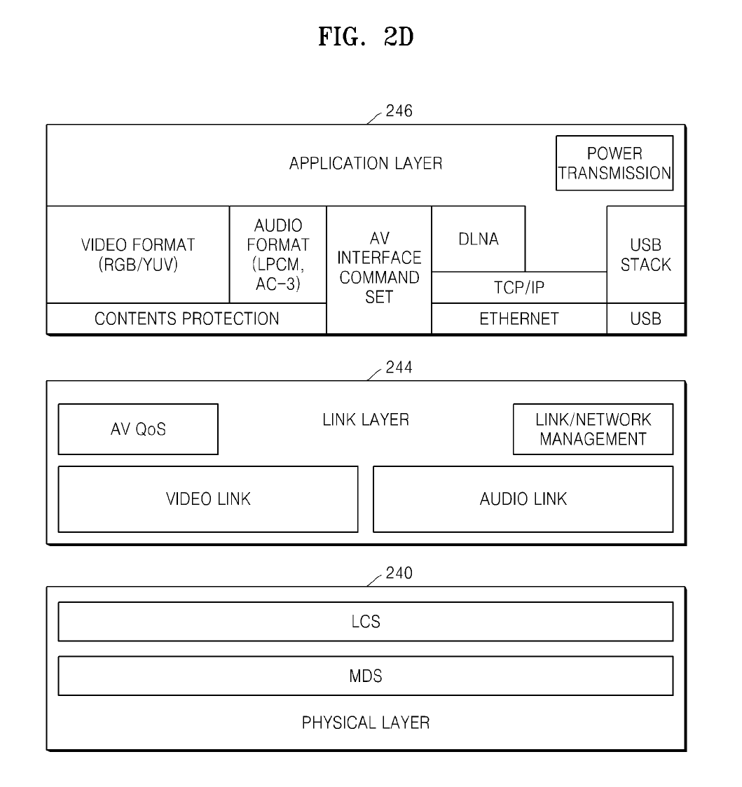

However, an AV link via an AV interface according to an exemplary embodiment supports bidirectional data transmission, and thus, in the network structure shown in FIG. 1, data may be transmitted to a device in another room and data may also be received from a device in another room. In particular, an AV link according to an exemplary embodiment enables bidirectional transmission of non-compressed video data. An example of bidirectional data transmissions will be described below in detail with reference to FIGS. 2A and 2B.

FIG. 2A is a diagram showing bidirectional data transmission via an AV interface according to an exemplary embodiment.

Referring to FIG. 2A, AV data (e.g., non-compressed video data) of a first source device 210 (e.g., a Blu-ray player) may be reproduced by a first sink device 216 (e.g., a projector), AV data of a second source device 212 (e.g., a set-top box) may be reproduced by a source/sink device 214 (e.g, a PC), and AV data of the source/sink device 214 may be reproduced by a first sink/switch device 218 (e.g., a TV).

The first sink/switch device 218 receives AV data of the first source device 210 and AV data of the second source device 212 from the first source device 210 and the second source device 212, performs time-division duplexing on the received AV data, and transmits the AV data to a second switch device 220.

When the second switch device 220 receives the AV data of the first source device 210 and the AV data of the second source device 212, the second switch device 220 relays the received AV data, transmits the AV data of the first source device 210 to the first sink device 216, and transmits the AV data of the second source device 212 to the source/sink device 214. Furthermore, the second switch device 220 receives Av data from the source/sink device 214 and transmits the received AV data to the first sink/switch device 218.

In links between the first sink/switch device 218 and the second switch device 220 and between the second switch device 220 and the source/sink device 214, AV data, that is, non-compressed video data is not transmitted monodirectionally, but is transmitted bidirectionally. Therefore, if each of the devices shown in FIG. 2A is connected via a single AV interface cable, an AV interface may perform bidirectional data transmission via a single cable and transmits AV data from a plurality of source devices using time-division duplexing.

FIG. 2B is a diagram showing bidirectional data transmission via an AV interface according to another exemplary embodiment.

Referring to FIG. 2B, AV data (e.g., non-compressed video data) of the first source device 210 (e.g., a Blu-ray player) may be reproduced by the first sink device 216 (e.g., a projector), AV data of the second source device 212 (e.g., a set-top box) may be reproduced by the source/sink device 214 (e.g., a PC), and AV data of the source/sink device 214 may be reproduced by the first sink/switch device 218 (e.g., a TV).

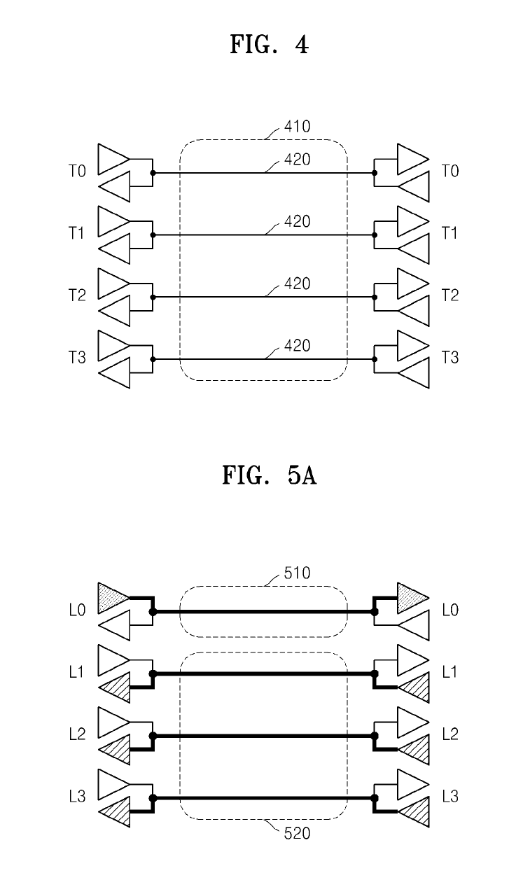

Although a method of transmitting data using time-division duplexing is shown in FIG. 2A, FIG. 2B shows a method of transmitting data using space-division duplexing. As described below with reference to FIG. 4, an AV link based on an AV interface according to an exemplary embodiment may include a plurality of sub-links. Furthermore, the plurality of sub-links may correspond to a plurality of spatially-separated lanes indicating physical connections between devices. Therefore, in AV data transmission as shown in FIG. 2B, data may be transmitted using space-division duplexing based on a plurality of sub-links.

For example, in FIG. 2B, the first sink/switch device 218 may transmit AV data of the first source device 210 and AV data of the second source device 212 using space-division duplexing via two sub-links In the same regard, AV data of the source/sink device 214 may be received from the second switch device 220 via another sub-link.

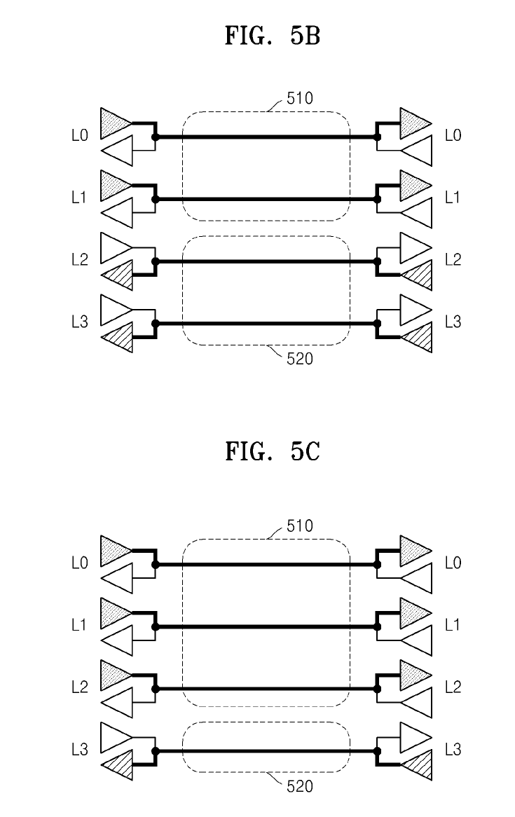

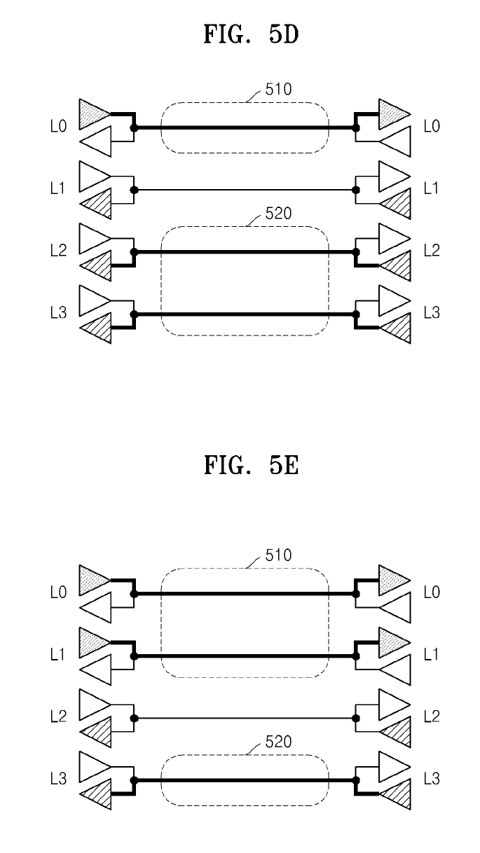

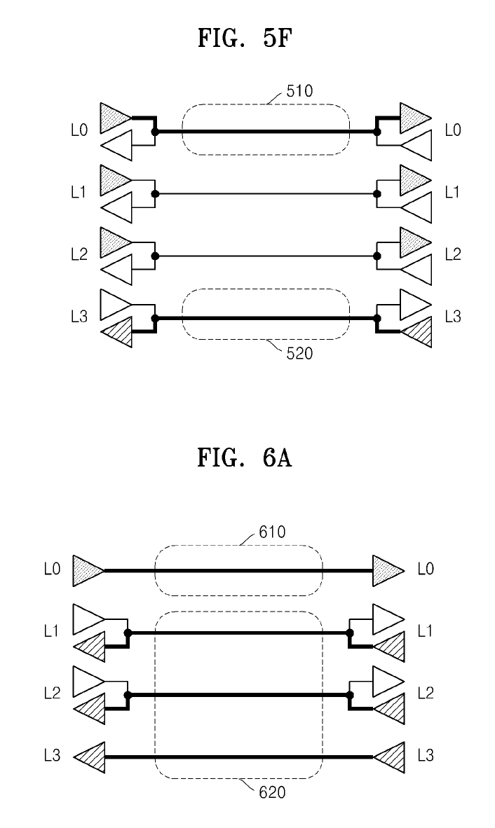

Bidirectional data transmission, transmission using time-division duplexing, and transmission using space-division duplexing via a single cable will be described below in detail with reference to FIG. 4, FIGS. 5A through 5F, FIGS. 6A through 6F, and FIGS. 7A and 7B.

It is not possible to perform bidirectional transmission of AV data via a conventional AV interface, such as DVI or HDMI. Therefore, as shown in FIG. 1, it is not possible to establish a data transmission network by using a conventional AV interface. However, an AV interface according to exemplary embodiments supports bidirectional data transmission via a single cable, and thus networks in which various devices are connected may be flexibly established.

FIG. 2C is a diagram showing a switch device according to an exemplary embodiment.

Referring to FIG. 2C, it is necessary to establish a network using an AV interface, and, for data transmission and reception, the switch devices 218 and 220 should be able to relay data of a source device and to precisely forward the data to a designated destination device from among a plurality of sink devices.

Therefore, switch devices perform switching of link layers. Switching is performed according to addresses of link layers allocated to source devices, sink devices, and source/sink devices that are connected via an AV interface. Data of a source device is forwarded to a sink device according to an address of a link layer. Addresses of link layers may be either medium access control (MAC) addresses, or addresses dynamically allocated to devices within a network established based on an AV interface. If it is assumed that data of a device #1 is transmitted to a device #2 in the embodiment shown in FIG. 2C, a switch device 230 parses a data packet received from the device #1 via a port #1 and determines the address of a destination device of the data packet. If it is determined that a device corresponding to the address of the destination device is connected to a port #2, the data packet received from the device #1 is forwarded to the device #2 via the port #2.

The switch device 230 forwards data based on mapping between ports and device addresses. The switch device 230 may learn addresses of devices connected to each of the port #1, the port #2, and a port #3. For example, the address of a device #n which transmitted a data packet may be determined by parsing the data packet received via a port #n, and the determined address of the device #n is mapped to the port #n. Based on learned mapping between ports and devices (e.g., a routing table), a data packet received via a particular port may be forwarded to another port corresponding to a destination address.

If there is no port corresponding to a destination address of a received data packet, the data packet may be forwarded to all ports except a port via which the data packet is received. In this case, a switch device may forward a received data packet to a destination device without generating a separate routing table by broadcasting the received data packet to all ports.

Referring back to FIG. 1, various types of data other than AV data, such as Ethernet data, universal serial bus (USB) data, etc., may be transmitted and received via an AV interface according to an exemplary embodiment. A detailed description thereof will be given below by providing an example in which a laptop 160 in the second room 120 transmits Ethernet data to a PC 161 in the third room 130 via a wireless LAN router 159 in the first room 110. Ethernet data generally refers to data that may be transmitted via a TCP/IP-based LAN.

However, since an AV interface according to an exemplary embodiment supports bidirectional data transmission, unlike conventional AV interfaces, Ethernet data may be transmitted via an AV interface according to an exemplary embodiment. Therefore, the laptop 160 transmits Ethernet data to the PC 161 via a network established based on an AV link. Here, switch devices in the network shown in FIG. 1 have a function for relaying Ethernet data. Ethernet data is forwarded from the wireless router 159 to the PC 161 by switching link layers.

According to another exemplary embodiment, in the case of transmitting USB data of a camera 162 to the laptop 160, switch devices forward the USB data to the laptop 160 using functions of switching USB data. Since various types of data other than AV data are transmitted via an AV interface, various types of devices may be connected to a network established based on an AV interface and may freely transmit and receive data. Switch devices relay USB data by switching of link layers.

Furthermore, data for controlling a device or a network may also be transmitted and received via an AV interface according to an exemplary embodiment. For example, a user may control the AV receiver 152 in the first room 110 by operating the TV 153 in the same mom. The user controls the AV receiver 152 by transmitting data for controlling the AV receiver 152 via an AV interface by operating the TV 153. Furthermore, the TV 156 or the set-top box 158 in another room, which are connected to a network established based on an AV interface, may be remotely controlled via the AV interface.

Data for controlling a network connected via an AV interface may also be transmitted via the AV interface, and thus not only data for setting up a link, but also data for managing the network may be transmitted via the AV interface as data for controlling the network.

Furthermore, power may also be forwarded via an AV interface according to an exemplary embodiment. Similar to forwarding power via a USB interface, predetermined power may be forwarded to a mobile device via an AV link. Predetermined power for charging or operating a mobile device (e.g., from 5 watts to 10 watts, 5 volts) is transmitted via an AV link.

FIG. 2D is a diagram showing network layer structure of an AV interface according to an exemplary embodiment.

As described above with reference to FIGS. 2A, 2B, and 2C, the network layer structure as shown in FIG. 2D may be utilized for bidirectional transmission of various types of data via an AV interface according to an exemplary embodiment.

Referring to FIG. 2D, a network layer structure according to an exemplary embodiment includes a physical layer 240, a link layer 244, and an application layer 246.

The physical layer 240 is a layer which converts data of a link layer into physical signals so as to transmit the data via a cable. Although FIG. 2D shows a case in which only one physical layer exists, one physical layer may be divided into at least two physical layers according to types of data. For example, one physical layer may be divided into a video physical layer for transmitting video data, such as non-compressed video data, and a data physical layer for transmitting types of data other than video data, such as audio data, Ethernet data, USB data, and control data, for example.

Furthermore, the physical layer 240 may include a logical coding sublayer (LCS) for coding data of a link layer and a medium dependent sublayer (MDS) for converting coded data into signals dependent on characteristics of a data transmission medium, that is, a channel.

The link layer 244 provides a function for precisely forwarding data of an application layer to a destination device. The link layer 244 may include a video link sublayer for transmitting and receiving video data and a data link sublayer for transmitting and receiving data other than video data. Furthermore, the link layer 244 may further include an AV quality of service (QoS) sublayer for assuring quality of AV data transmission and a link/network management sublayer for managing an AV link and a network based on the AV link.

The application layer 246 may include a video data format sublayer for transmitting and receiving non-compressed video data, an audio data format sublayer for transmitting and receiving audio data, and a content protection sublayer for protecting copyrights of AV contents. Furthermore, the application layer 246 may further include an Ethernet sublayer, a TCP/IP layer, and a DLNA layer related to transmission and reception of Ethernet data. Furthermore, the application layer 246 may further include a USB stack related to transmission of USB data and an AV interface command set related to transmission of control data.

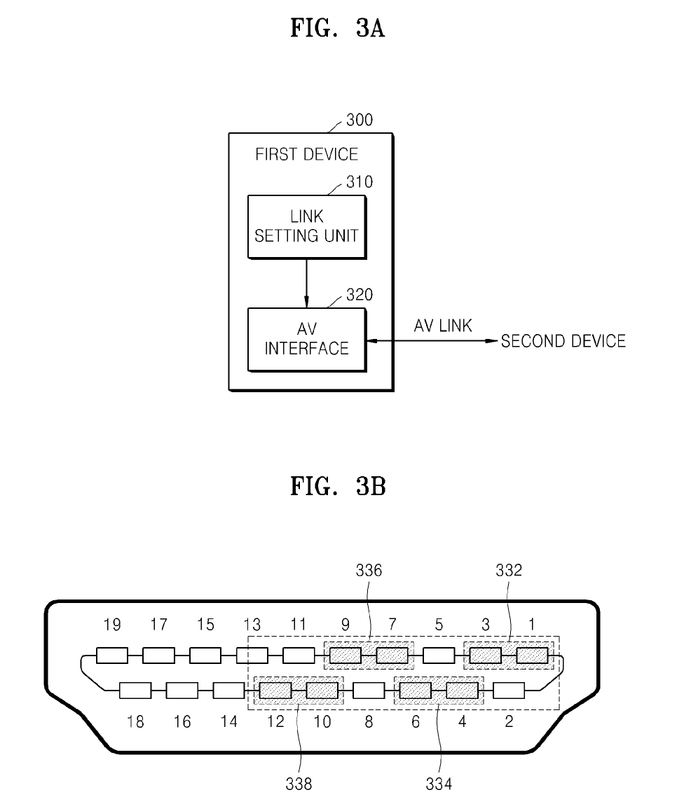

FIG. 3A is a diagram showing a device including an AV interface according to an exemplary embodiment.

A first device 300 shown in FIG. 3A is a device existing in a network connected via an AV interface according to an exemplary embodiment and may be a source/leaf device, a source/switch device, a switch device, a sink/switch device, or a sink/leaf device. Referring to FIG. 3A, the device 300 according to an exemplary embodiment includes a link setting unit 310 and an AV interface 320.

The link setting unit 310 establishes a link supporting bidirectional data transmission based on an AV interface interconnecting the first device 300 and a second device. An AV link is established based on an AV interface according to an exemplary embodiment, and the established AV link is set up. Here, directions and/or rate of data transmission of a link or a plurality of sub-links described below with reference to FIGS. 5A through 5F, FIGS. 6A through 6F, FIGS. 8A and 8B, and FIG. 9 may be set up. The link setting unit 310 is an optional component, and thus, if a link is static and it is not necessary to set up the link, the link setting unit 310 may be omitted.

The AV interface 320 performs at least one of data transmission to a second device and data reception from the second device via a link established by the link setting unit 310. As described above, the AV link is a link supporting bidirectional data transmission. Data that may be transmitted and received by the AV interface 320 may be at least one of AV data, Ethernet data, USB data, and control data. The AV data may be non-compressed video data.

In the case where the first device 300 relays data received from another device by acting as a switch device, the AV interface 320 receives data from at least one other device and transmits the data to the second device. In the case of receiving data from a plurality of devices, the received data may be transmitted to the second device using time-division duplexing or space-division duplexing.

To assure backward compatibility, the AV interface 320 may share a form factor that is the same as that of a conventional AV interface, such as HDMI. Although devices may be connected via ports and pins similar to a HDMI cable, functions performed by each of the pins may be different from those of HDMI, and thus the AV interface 320 may be used for bidirectional data transmission. For example, from among 19 pins of the HDMI, a part of the 19 pins may be allocated to transmission of data to the second device, and another part of the 19 pins may be allocated to reception of data from the second device, and thus bidirectional data transmission may be performed by using a HDMI cable.

FIG. 3B is a diagram showing mapping between the HDMI and an AV interface, according to an embodiment of the present invention.

Referring to FIG. 3B, a part or all of a plurality of pins of the HDMI may be used as an AV interface according to exemplary embodiments. For example, from among 19 pins of the HDMI, first through third pins may be used as a first lane T1 described below with reference to FIG. 4, fourth through sixth pins may be used as a second lane T2 described below, ninth and seventh pins may be used as a third lane T3 described below, and tenth and twelfth pins may be used as a fourth lane T4 described below.

One of two pins of each of the lanes is used for data transmission, whereas the other one of the two pins of each of the lanes is used for data reception. Therefore, each of the lanes supports bidirectional data transmission.

When a HDMI cable is connected to the AV interface 320, it may be automatically detected whether the HDMI cable is used for data transmission according to the HDMI interface or the HDMI cable is used for bidirectional data transmission according to an AV interface according to exemplary embodiments. Signals input via pins of the HDMI cable differ from the case of transmitting data according to the HDMI interface to the case of transmitting data according to an AV interface according to exemplary embodiments, and thus it may be determined whether the HDMI cable is used for bidirectional data transmission according to an AV interface according to exemplary embodiments by detecting waveforms and frequencies of input signals.

Furthermore, particular pin(s) from among pins of a HDMI cable may not be used for bidirectional data transmission according to an AV interface according to exemplary embodiments, and thus, if there is(are) particular pin(s) via which data is not transmitted or received, it may be determined that the HDMI cable is used for bidirectional data transmission according to an AV interface according to exemplary embodiments.

The first device 300 may automatically detect whether another device is connected thereto via an AV interface according to an exemplary embodiment. When a cable for establishing an AV link according to an exemplary embodiment is connected to the AV interface 320, it may be determined whether the cable for establishing an AV link is connected by detecting electrical changes of the AV interface 320.

Furthermore, the AV interface 320 periodically polls a signal for detecting connection of an AV link via a port, via which an AV link may be established, and, if a response with respect to the polled signal is received from the port, it may be determined that a cable for establishing an AV link is connected.

FIG. 4 is a diagram showing a link established based on an AV interface according to an exemplary embodiment.

Referring to FIG. 4, an AV link 410 is established based on a plurality of lanes 420. Each of the lanes 420 indicates a physical connection between devices and may correspond to respective twisted pairs (TP). Since data may be transmitted bidirectionally via each of the lanes 420, transmission and reception of data may be alternately performed using time-division duplexing.

The plurality of lanes 420 may transmit and receive data at different data transmission rates according to types of cables, lengths of cables, and efficiencies of devices. Data transmission rate is not fixed, and may be dynamically set to different values according to environments surrounding the AV link 410. Furthermore, different transmission rates may be set with respect to each of the plurality of lanes 420. From among the plurality of lanes 420, a high data transmission rate may be set with respect to a lane via which data requiring fast transmission and reception, such as video data, is transmitted, whereas a low data transmission rate may be set with respect to a lane via which control data or audio data is transmitted and received.

FIGS. 5A through 5F are diagrams showing a plurality of sub-links for bidirectional data transmission according to an exemplary embodiment.

Referring to FIGS. 5A through 5F, a link according to an AV interface according to an exemplary embodiment may include a plurality of sub-links A single link may be divided into a plurality of logically distinguishable sub-links, and directions for data transmission may be set up with respect to each of the plurality of sub-links. The plurality of logically distinguishable sub-links may also respectively correspond to the plurality of physically separated lanes shown in FIG. 4. For example, a sub-link L0 shown in FIGS. 5A through 5C may correspond to the lane T0 shown in FIG. 4, a sub-link L1 may correspond to the lane T1, and sub-links L2 and L3 may respectively correspond to the lanes T2 and T3.

Referring to FIG. 5A, the sub-link L0 supporting bidirectional data transmission is used for forward data transmission, whereas the sub-links L1, L2, and L3 supporting bidirectional data transmission are used for backward data transmission. As shown in FIGS. 5A through 5F, if a total number of the sub-links is four, a ratio between sub-links 510 for forward data transmission and sub-links 520 for backward data transmission may be any of various ratios, such as 1:3, 2:2, 3:1, 2:1, 1:2, and 1:1. As described above in relation to FIG. 3, the link setting unit 310 decides directions and/or rate of data transmission of each sub-link, and thus a ratio between the sub-links 510 for forward data transmission and the sub-links 520 for backward data transmission may be decided based on configurations made by the link setting unit 310.

Some sub-links may not be used. For example, if the sub-links L1 and L2 are not used as shown in FIG. 5F, a ratio between the sub-links 510 for forward data transmission and the sub-links 520 for backward data transmission becomes 1:1. In the same regard, as shown in FIGS. 5D and 5E, a ratio between the sub-links 510 for forward data transmission and the sub-links 520 for backward data transmission may become 1:2 or 2:1, even though the total number of sub-links is four.

However, to support bidirectional data transmission, it is necessary to use at least one sub link for backward data transmission. In other words, it is necessary to secure at least one forward sub-link and at least one backward sub-link to assure bidirectional data transmission.

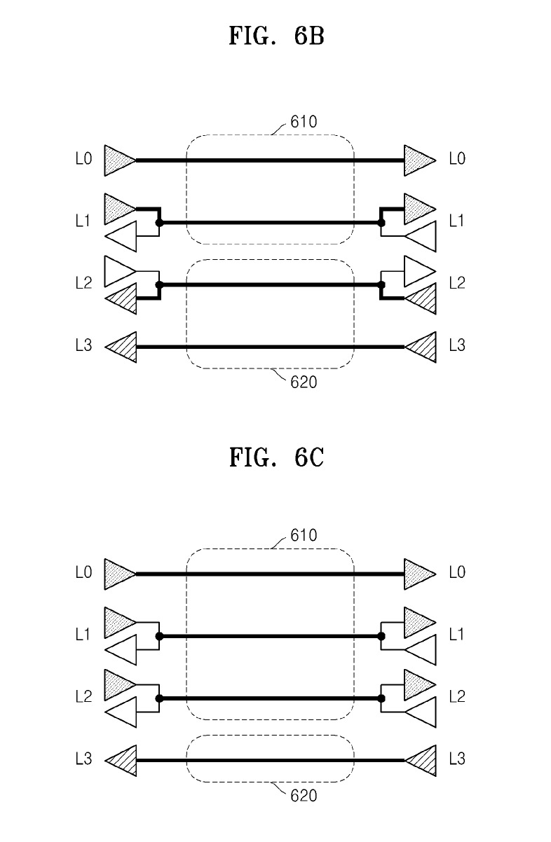

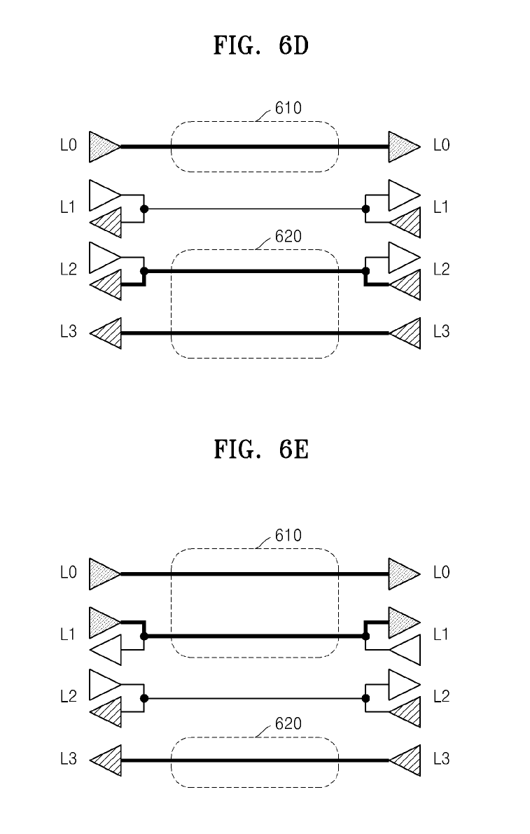

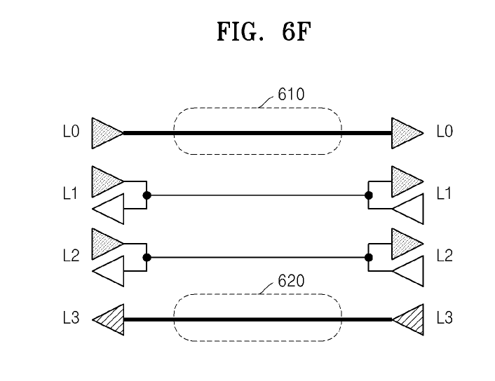

FIGS. 6A through 6F are diagrams showing a plurality of sub-links for bidirectional data transmission according to another exemplary embodiment.

Referring to FIG. 6A, unlike in FIGS. 5A through 5C, the sub-links L0 and L3 only support monodirectional data transmission. As described, it is necessary for a link established by using an AV interface according to the exemplary embodiments to support bidirectional data transmission, and thus a link should not only include at least one sub-link for forward data transmission, but also include at least one sub-link for backward data transmission.

Therefore, the sub-links L0 and L3 may be sub-links only supporting monodirectional data transmission. As a link includes two sub-links supporting monodirectional data transmission, the link secures one sub-link for forward data transmission and one sub-link for backward data transmission.

Next, directions of data transmission of the other two sub-links supporting bidirectional data transmission are adjusted. FIG. 6A shows a case in which, since both of the sub-links L1 and L2 are used for backward data transmission, a ratio between sub-links 610 for forward data transmission and sub-links 620 for backward data transmission is set to 1:3, and FIG. 6B shows a case in which, since the sub-link L1 is used for forward data transmission and the sub-link L2 is used for backward transmission, a ratio between the sub-links 610 for forward data transmission and the sub-links 620 for backward data transmission is set to 2:2. FIG. 6C shows a case in which, since both of the sub-links L1 and L2 are used for forward data transmission, a ratio between the sub-links 610 for forward data transmission and the sub-links 620 for backward data transmission is set to 3:1. Furthermore, as shown in FIGS. 6D through 6F, a ratio between the sub-links 610 for forward data transmission and the sub-links 620 for backward data transmission may be set to 2:1, 1:2, or 1:1 by not using the sub-link L1 and/or the sub-link L2 for data transmission.

As shown in FIGS. 5A through 5F and FIGS. 6A through 6F, a ratio between the sub-links 610 for forward data transmission and the sub-links 620 for backward data transmission may be dynamically adjusted, and thus a data transmission rate in a particular direction may be variably adjusted within a wide range.

For example, if the maximum data transmission rate of each of sub-links is 3 Gbps, each of forward and backward data transmission may be performed at a data transmission rate of 6 Gbps by using two sub-links for forward data transmission and using the other two sub-links for backward data transmission as shown in FIGS. 5B and 6B. Therefore, an AV interface according to an exemplary embodiment may be used even in the cases where it is necessary to bidirectionally transmit data at a high data transmission rate (e.g., 5 Gbps), such as when using USB 3.0.

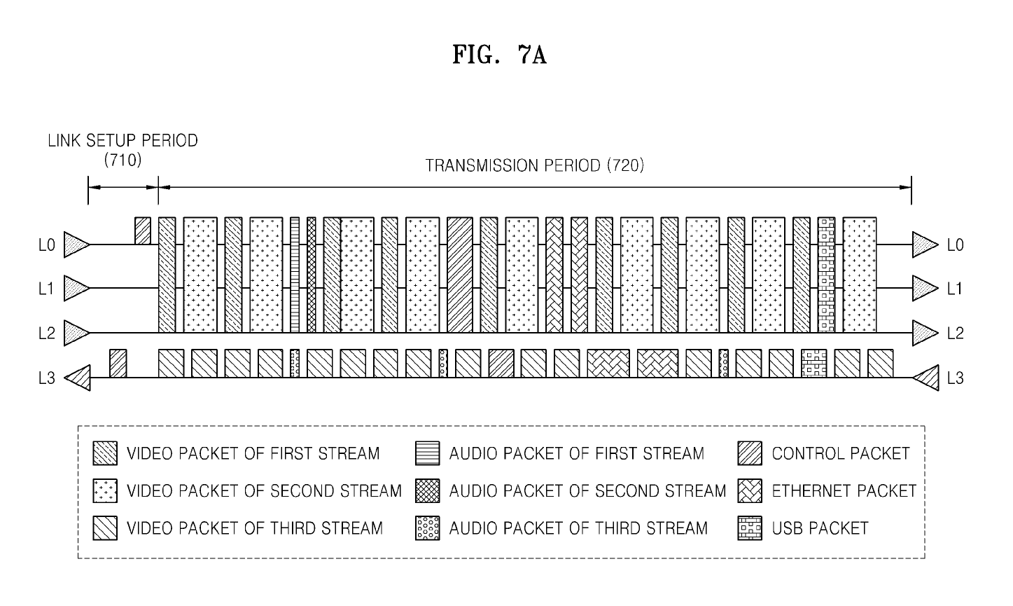

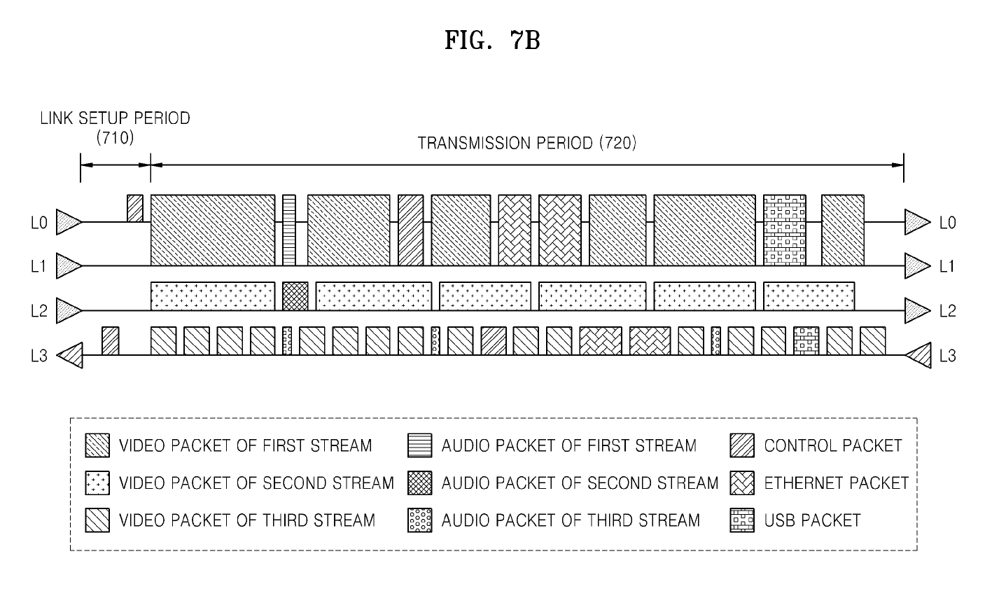

FIG. 7A is a diagram showing transmission and reception of data using time-division duplexing according to an exemplary embodiment.

Referring to FIG. 7A, the sub-links L0, L1, and L2 are set as sub-links for forward data transmission, whereas the sub-link L3 is set as a sub-link for backward data transmission, as shown in FIG. 5C or FIG. 6C.

During a link setup period 710, two devices connected to each other via an AV interface according to an exemplary embodiment transmit and receive control data for setting up a link. Directions and rates of data transmission of sub-links may be set by transmitting and receiving control data using the sub-links L0 and L3. The sub-links L0 and L3 are default sub-links for setting up a link, and a link may also be set up by using sub-links other than the example shown in FIG. 7.

During a transmission period 720, a plurality of packets are transmitted using time-division duplexing. In other words, video data packets and audio data packets with respect to a plurality of AV streams, that is, a first AV stream and a second AV stream, are time-division duplexed and are forward transmitted via the sub-links L0, L1, and L2. A control data packet, an Ethernet data packet, and a USB data packet are also time-division duplexed together with the AV streams and are forward transmitted via an AV interface.

During the transmission period 720, a video data packet and an audio data packet with respect to a third AV stream are time-division duplexed and backward transmitted via the sub-link L3. During the backward data transmission, a control data packet, an Ethernet data packet, and a USB data packet may also be time-division duplexed together with the AV stream.

If it is decided to use no particular sub-link during the link setup period 710, data may be transmitted and received by using only a part of the sub-links L0 through L3. For example, data may be transmitted and received by using only the sub-link L0 for forward data transmission and the sub-link L3 for backward data transmission. All of a video data packet, an audio data packet, an Ethernet data packet, a USB data packet, and a control data packet are time-division duplexed and transmitted forward or backward.

FIG. 7B is a diagram showing transmission and reception of data using time-division duplexing and space-division duplexing according to an exemplary embodiment.

Referring to FIG. 7B, all of the sub-links L0, L1, and L2 are used for forward data transmission as in the embodiment shown in FIG. 7A. However, unlike in the embodiment shown in FIG. 7A, although the sub-links L0 and L1 are used together to transmit the same data, the sub-link L2 is used to transmit data different from that transmitted via the sub-links L0 and L1. In other words, different data may be transmitted via each of sub-links by using space-division duplexing.

Video data packet and audio data packet of the first AV stream are forward transmitted via the sub-links L0 and L1, whereas video data packet and audio data packet of the second AV stream are forward transmitted via the sub-link L2. Furthermore, video data packet and audio data packet of the third AV stream are backward transmitted via the sub-link L3.

After data to be transmitted and received via each of sub-links are decided to be different from each other using space-division duplexing, at least two of a video data packet, an audio data packet, a control data packet, an Ethernet data packet, and a USB data packet may be forward or backward transmitted via a single lane using time-division duplexing.

The transmission and/or reception of data shown in FIGS. 7A and 7B may be performed based on a super frame structure. Transmission and/or reception of data may be performed based on a super frame structure including a beacon period for transmitting and receiving data regarding the super frame structure and/or a network structure, a contention access period, and a contention-free access period. The contention access period refers to a period during which frames for data transmission are allocated to a plurality of devices based on contention and the plurality of devices transmit and/or receive data within allocated frames, whereas the contention-free access period refers to a period during which data is transmitted and/or received within pre-allocated frames without contention.

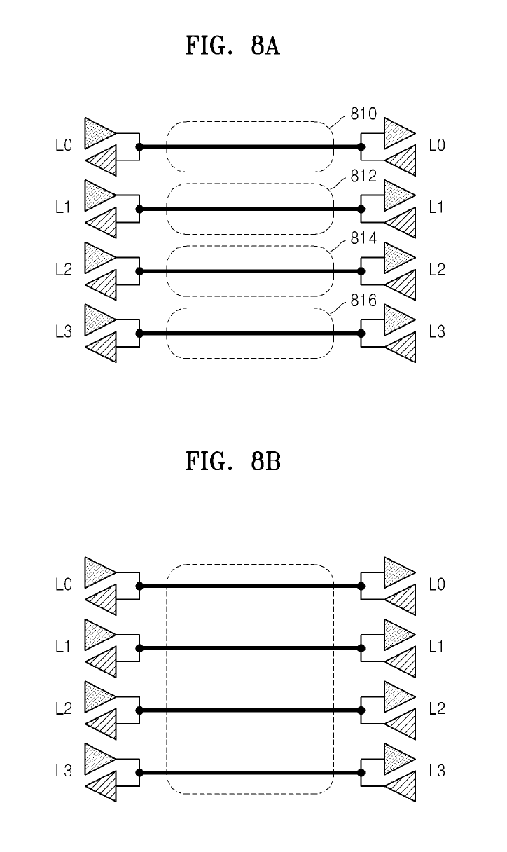

FIGS. 8A and 8B are diagrams showing a plurality of sub-links for bidirectional data transmission according to another exemplary embodiment.

FIGS. 5A through 5F and FIGS. 6A through 6F show embodiments in which data may be transmitted bidirectionally as directions of data transmission of sub-links are set up during a link setup period and a link includes at least one sub-link for forward data transmission and at least one sub-link for backward data transmission.

However, FIGS. 8A and 8B show embodiments in which bidirectional data transmission is performed via a link by using all of a plurality of sub-links for forward data transmission and backward data transmission. If directions of data transmission of each of sub-links may be quickly switched due to a sufficiently short lock time of a phase-locked loop (PLL), each of the sub-links may be used for bidirectional data transmission.

As shown in FIG. 8A, each of sub-links 810 through 816 may be individually used for forward data transmission and backward data transmission. Each of the sub-links 810 through 816 are individually controlled and used for forward data transmission or backward data transmission.

Alternatively, as shown in FIG. 8B, a plurality of sub-links may be grouped into a single group and controlled simultaneously. Data is forward or backward transmitted by simultaneously controlling a plurality of sub-links. In other words, in the embodiment shown in FIG. 8A, when data is forward transmitted via the sub-link L0, data may also be backward transmitted via the sub-link L1. The sub-links L2 and L3 forward or backward transmit data regardless of directions of data transmission of other sub-links However, in the embodiment shown in FIG. 8B, the sub-links L0, L1, L2, and L3 may not transmit data in different directions, and all of the sub-links L0, L1, L2, and L3 are simultaneously used for forward data transmission or backward data transmission.

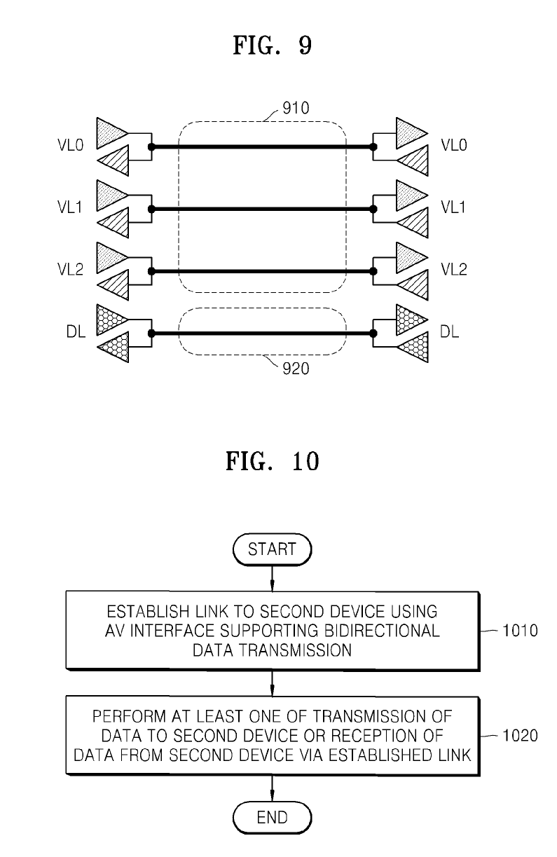

FIG. 9 is a diagram showing a plurality of sub-links for bidirectional data transmission according to another exemplary embodiment.

Referring to FIG. 9, data may be transmitted via different sub-links according to types of data. In other words, a link according to an exemplary embodiment may include at least one exclusive sub-link for transmitting or receiving a particular type of data. In the embodiment shown in FIG. 9, three sub-links supporting bidirectional data transmission may be set as sub-links VL0 through VL2 910 for transmitting non-compressed video data, and the other link may be set as a sub-link DL 920 for transmitting data other than video data.

Two devices connected via an AV interface may set up directions and rates of data transmission of the sub-links VL0 through VL2 910 by transmitting and receiving control data via the sub-link DL 920 during a link setup period and may transmit and receive non-compressed video data during a transmission period via the sub-links VL0 through VL2 910 based on the configuration set up in the link setup period.

A ratio between the sub-links for forward data transmission and sub-links for backward data transmission from among the sub-links VL0 through VL2 910 for video data transmission may be any of various ratios, i.e., 0:3, 1:2, 2:1, 3:0, 0:2, 1:1, 2:0, 0:1, and 0:0.

Furthermore, a part of the sub-links VL0 through VL2 910 for video data transmission may not be used. For example, the sub-links VL1 and VL2 may not be used. Even if a part of the sub-links VL0 through VL2 910 are not used, it may be required to use the sub-link VL0 to secure a minimum number of sub-links for video data transmission.

FIG. 10 is a flowchart for describing in more detail a method of transmitting and receiving data based on an AV interface according to an exemplary embodiment. FIG. 10 shows a method according to which a first device and a second device connected via an AV interface according to an exemplary embodiment transmit and receive data via a link supporting bidirectional transmission of non-compressed video data.

Referring to FIG. 10, in an operation 1010, a first device and a second device connected via an AV interface establish a link supporting bidirectional data transmission. Each of the first device and the second device may be a source/leaf device, a source/switch device, a switch device, a sink/switch device, or a sink/leaf device.

As described above in relation to FIGS. 5A through 5F, FIGS. 6A through 6F, FIGS. 8A and 8B, and FIG. 9, a link may include a plurality of sub-links with set directions and rates of data transmission. As shown in FIGS. 5A through 5F and FIGS. 6A through 6F, sub-links may be set to include at least one sub-link for data transmission (corresponding to forward data transmission) and at least one sub-link for data reception (corresponding to backward data transmission), or may be set, such that all of the plurality of sub-links support bidirectional data transmission as shown in FIGS. 8A and 8B. Furthermore, as shown in FIG. 9, sub-links may be allocated according to types of data, and directions of data transmission of the allocated sub-links may be adjusted.

To set directions and rates of data transmission of the plurality of sub-links, the operation 1010 may include a step of setting directions and rates of data transmission of the plurality of sub-links during a link setting time.

In an operation 1020, the first device performs at least one of transmission of data to the second device or reception of data from the second device via the link established in the operation 1010. As described above, transmission of data to the second device corresponds to forward data transmission, whereas reception of data from the second device corresponds to backward data transmission. Data transmitted here may include AV data, Ethernet data, USB data, and control data.

If the first device is a switch device which receives data from another device and relays the data, data received from at least one other device may be forwarded to the second device by switching link layers. Video data and audio data with respect to a plurality of AV frames may be received from a plurality of source devices and the received video data and audio data may be forwarded to the second device by using time-division duplexing and/or space-division duplexing.

Since the first device may transmit or receive a plurality of pieces of data via the link established in the operation 1010, a plurality of pieces of data may be transmitted or received using time-division duplexing and/or space-division duplexing as shown in FIGS. 7A and 7B.

While the present invention has been particularly shown and described with reference to exemplary embodiments thereof, it will be understood by those of ordinary skill in the art that various changes in form and details may be made therein without departing from the spirit and scope of the present invention as defined by the following claims. Furthermore, the present invention can also be embodied as computer readable codes on a computer readable recording medium.

For example, a device for transmitting and receiving data via an AV interface according to an embodiment of the present invention may include a bus coupled to each of units of the device as shown in FIG. 3 and at least one processor connected to the bus. Furthermore, the device may include a memory which is connected to the bus to store commands, received messages, or generated messages and is coupled to the at least one processor for carrying out the commands as described above.

Furthermore, the computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

What is claimed is:

1. A method, performed by a first device, of transmitting and receiving data between the first device and a second device, the method comprising performing at least one of transmitting data to the second device and receiving data from the second device via a link, which is based on an audio/video (AV) interface and supports bidirectional transmission of non-compressed video data.

2. The method of claim 1, wherein the link comprises a plurality of sub-links capable of transmitting and receiving the data.

3. The method of claim 2, wherein the plurality of sub-links comprise at least one sub-link used only for data transmission and at least one sub-link used only for data reception.

4. The method of claim 1, wherein the link comprises a plurality of sub-links, and
the plurality of sub-links comprise a sub-link supporting data transmission only, a sub-link supporting data reception only, and at least one sub-link supporting both data transmission and data reception.

5. The method of claim 2, wherein the plurality of sub-links comprise at least one sub-link used only for at least one of transmission and reception of a particular type of data.

6. The method of claim 2, wherein the plurality of sub-links respectively correspond to a plurality of lanes which indicate physical connections between the first device and the second device via the AV interface.

7. The method of claim 2, wherein the performing of at least one of transmitting data to the second device and receiving data from the second device comprises transmitting a plurality of packets by using time-division duplexing of at least one of the plurality of sub-links used for data transmission.

8. The method of claim 2, wherein the performing of at least one of transmitting data to the second device and receiving data from the second device comprises receiving a plurality of packets by using time-division duplexing of at least one of the plurality of sub-links used for data reception.

9. The method of claim 7, wherein the plurality of packets comprises video data packets corresponding to a plurality of AV streams.

10. The method of claim 7, wherein the plurality of packets comprises at least one of an audio data packet, an Ethernet data packet, a universal serial bus (USB) data packet, and a control data packet, which is transmitted and received for controlling another device.

11. The method of claim 7, wherein the plurality of packets comprises at least one packet received from at least one external device.

12. The method of claim 11, wherein the transmitting of data to the second device comprises transmitting the at least one packet received from at least one external device by link layer switching.

13. The method of claim 1, wherein the performing of at least one of transmitting data to the second device and receiving data from the second device comprises:
establishing a link, which supports bidirectional transmission of non-compressed video data based on the AV interface, to the second device; and
performing at least one of transmitting data to the second device and receiving data from the second device via the established link.

14. The method of claim 2, further comprising setting directions and rates of data transmission of the plurality of sub-links during a link setup period before the performing of at least one of transmitting data to the second device and receiving data from the second device.

15. A data transmitting and receiving device of a first device for transmitting and receiving data to and from a second device, the first device comprising an AV interface which performs at least one of transmitting data to the second device and receiving data from the second device via a link, which is based on an audio/video (AV) interface and supports bidirectional transmission of non-compressed video data.

16. The data transmitting and receiving device of claim 15, wherein the link comprises a plurality of sub-links capable of transmitting and receiving the data.

17. The data transmitting and receiving device of claim 16, wherein the plurality of sub-links comprise at least one sub-link used only for data transmission and at least one sub-link used only for data reception.

18. The data transmitting and receiving device of claim 15, wherein the link comprises a plurality of sub-links, and
the plurality of sub-links comprise a sub-link supporting data transmission only, a sub-link supporting data reception only, and at least one sub-link supporting both data transmission and data reception.

19. The data transmitting and receiving device of claim 16, wherein the plurality of sub-links comprise at least one sub-link used only for at least one of transmission and reception of a particular type of data.

20. The data transmitting and receiving device of claim 16, wherein the plurality of sub-links respectively correspond to a plurality of lanes which indicate physical connections between the first device and the second device via the AV interface.

21. The data transmitting and receiving device of claim 16, wherein the AV interface transmits a plurality of packets by using time-division duplexing of at least one of the plurality of sub-links used for data transmission.

22. The data transmitting and receiving device of claim 16, wherein the AV interface receives a plurality of packets by using time-division duplexing of at least one of the plurality of sub-links used for data reception.

23. The data transmitting and receiving device of claim 21, wherein the plurality of packets comprises video data packets corresponding to a plurality of AV streams.

24. The data transmitting and receiving device of claim 21, wherein the plurality of packets comprise at least one of an audio data packet, an Ethernet data packet, a universal serial bus (USB) data packet, and a control data packet, which is transmitted and received for controlling another device.

25. The data transmitting and receiving device of claim 21, wherein the plurality of packets comprise at least one packet received from at least one external device.

26. The data transmitting and receiving device of claim 25, wherein the AV interface transmits the at least one packet received from the at least one external device by link layer switching.

27. The data transmitting and receiving device of claim 15, wherein the AV interface performs at least one of:
establishing a link, which supports bidirectional transmission of non-compressed video data based on the AV interface, to the second device; and
performing at least one of transmitting data to the second device and receiving data from the second device via the established link.

28. The data transmitting and receiving device of claim 16, further comprising a link setup unit for setting directions and rates of data transmission of the plurality of sub-links during a link setup period before the performing of at least one of transmitting data to the second device and receiving data from the second device.

29. A computer readable recording medium having recorded thereon a computer program for implementing the method of claim 1.

30. The method of claim 2, wherein the performing of at least one of transmitting data to the second device and receiving data from the second device comprises transmitting a plurality of packets by using space-division duplexing of at least one of the plurality of sub-links used for data transmission.

31. The data transmitting and receiving device of claim 16, wherein the AV interface transmits a plurality of packets by using space-division duplexing of at least one of the plurality of sub-links used for data transmission.
